(19) United States
(12) Patent Application Publication
(10) Pub. No.: US 2018/0142570 A1
(43) Pub. Date: May 24, 2018

(54) PURGING LIQUID FUEL NOZZLES AND SUPPLY TUBING WITH THE ASSISTANCE OF A FLOW DIVIDER

(71) Applicant: Siemens Aktiengesellschaft, München (DE)

(72) Inventors: James R. HEALEY, Charlotte, NC (US); Jason A. MESMER, Winter Springs, FL (US)

(21) Appl. No.: 15/570,408

(22) PCT Filed: Apr. 28, 2015
(86) PCT No.: PCT/US2015/027862

§ 371 Date: Oct. 30, 2017

(51) Int. Cl. F01D 25/00; F02C 3/30; F02C 7/232; F02C 9/26; F23K 5/04

(52) U.S. Cl. CPC F01D 25/002; F02C 3/305; F02C 7/232; F02C 9/263; F05D 2270/16; F05D 2230/72; F05D 2240/35; F05D 2260/602; F05D 2270/07; F23K 5/04

(57) ABSTRACT

A fuel delivery system for a gas turbine engine that employs a technique for purging fuel delivery tubes in an effective manner. The fuel delivery system includes at least one multifunction valve that has a flow through position and a bi-directional purge position. The fuel delivery system also includes at least one flow divider that is positioned downstream from the multifunction valve and divides the flow of fuel from the valve into a number of the fuel delivery tubes, where a separate fuel delivery tube is provided for each combustor in the engine. The flow divider includes a pump element for all of the fuel delivery tubes that can operate in a forward and a reverse direction. Purge water provided downstream from the flow divider for each of the fuel delivery tubes can be pumped by the flow divider when the multifunction valve is in the purge position.

### BACKGROUND OF THE INVENTION

### Field of the Invention

This invention relates generally to a fuel delivery system for a gas turbine engine and, more particularly, to a fuel delivery system for a gas turbine engine that includes a flow divider positioned downstream from a multifunction valve that allows purge water to be pumped upstream through the multifunction valve to a drain.

### Discussion of the Related Art

The world's energy needs continue to rise which provides a demand for reliable, affordable, efficient and environmentally-compatible power generation. A gas turbine engine is one known machine that provides efficient power, and often has application for an electric generator in a power plant, or engines in an aircraft or a ship. A typical gas turbine engine includes a compressor section, a combustion section and a turbine section. The compressor section provides a compressed airflow to the combustion section where the air is mixed with a fuel, such as natural gas, diesel fuel oil, etc. The combustion section includes a plurality of circumferentially disposed combustors that receive the fuel to be mixed with the air and ignited to generate a working gas. The working gas expands through the turbine section and is directed across rows of blades therein by associated vanes. As the working gas passes through the turbine section, it causes the blades to rotate, which in turn causes a shaft to rotate, thereby providing mechanical work.

Some gas turbine engines of the type referred to above include a fuel delivery system that delivers a liquid fuel oil under a suitable pressure and flow rate to the injectors associated with the combustors in the combustion section of the engine. Under certain operating conditions, such as low loads, the flow of the fuel oil to a particular combustor may be temporarily stopped. Because of the high temperatures in the combustion section of the engine, the fuel oil that may be standing in a fuel delivery tube may be significantly heated and, depending on its distance from the combustor, cause carbon deposits to form on the inside of the fuel delivery tube, thus causing flow and performance issues. Hence, during this and other system operation conditions, it is known in the art to purge the fuel delivery tubes using water so as to temporarily remove the fuel oil from the delivery tube and prevent such carbon deposits. However, known techniques for providing this water purge have certain drawbacks, such as not being able to know if a particular fuel delivery tube has a high enough flow rate of water to purge the fuel upstream from a location where the purge water is provided to the fuel delivery tube.

### SUMMARY OF THE INVENTION

The present disclosure describes a fuel delivery system for a gas turbine engine that employs a technique for purging fuel oil from fuel delivery tubes in an effective manner. The fuel delivery system includes at least one multifunction valve that has a flow-through position and a bi-directional purge position, where fuel oil downstream from the valve can flow back through the valve to a drain. The fuel delivery system also includes at least one flow divider that is positioned downstream from the multifunction valve and divides the flow of fuel from the valve into a number of the fuel delivery tubes, where a separate fuel delivery tube is provided for each combustor in the engine. The flow divider acts as a pump for each of the fuel delivery tubes, which can operate in both a forward and a reverse direction. Purge water provided downstream from the flow divider for each of the fuel delivery tubes can be pumped by the flow divider when the multifunction valve is in the purge position so as to effectively purge all of the fuel delivery tubes.

Additional features of the present invention will become apparent from the following description and appended claims, taken in conjunction with the accompanying drawings.

### BRIEF DESCRIPTION OF THE DRAWINGS

FIG. 1 is a diagram of a gas turbine engine system including a gas turbine engine and a fuel delivery system, where a multifunction valve upstream from a flow divider is in a fuel delivery position;

FIG. 2 is a schematic diagram of a portion of the fuel delivery system shown in FIG. 1, where a multifunction valve upstream from a flow divider is in a bi-directional purge position; and

FIG. 3 is a schematic diagram of the portion of the fuel delivery system shown in FIG. 2, where the multifunction valve is in a drain position.

### DETAILED DESCRIPTION OF THE EMBODIMENTS

The following discussion of the embodiments of the invention directed to a fuel delivery system for a gas turbine engine is merely exemplary in nature, and is in no way intended to limit the invention or its applications or uses. For example, as mentioned, the fuel delivery system has particular application for a gas turbine engine. However, the fuel delivery system of the invention may have application for other types of devices and power plants.

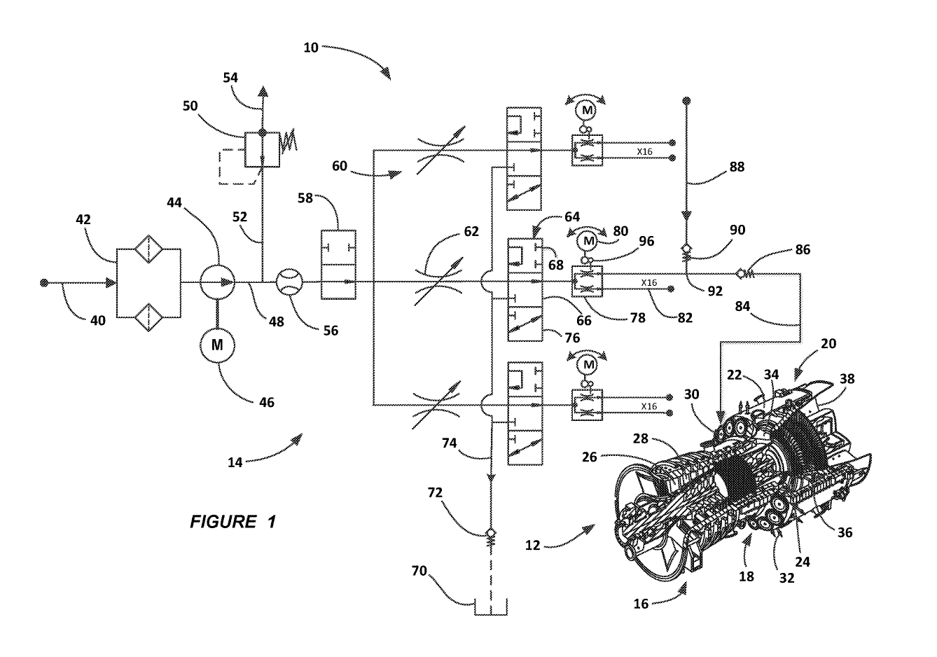

FIG. 1 is a diagram of a gas turbine engine system 10 including a gas turbine engine 12 and a fuel delivery system 14 that delivers liquid fuel, such as a diesel fuel oil, to the gas turbine engine 12 at a desired flow rate and pressure. The gas turbine engine 12 includes a compressor section 16, a combustion section 18 and a turbine section 20 all enclosed within an outer housing or casing 22, where operation of the engine 12 causes a central shaft or rotor 24 to rotate, thus creating mechanical work. The engine 12 is illustrated and described by way of a non-limiting example to provide context to the invention discussed below. Those skilled in the art will appreciate that other gas turbine engine designs can also be used in connection with the invention as described below. Rotation of the rotor 24 draws air into the compressor section 16 where it is directed by vanes 26 and compressed by rotating blades 28 to be delivered to the combustion section 18, where the compressed air is mixed with the fuel, and where the fuel/air mixture is ignited to create a hot working gas. More specifically, the combustion section 18 includes a number of circumferentially disposed combustors 30, sixteen in this non-limiting example, each receiving the fuel that is injected as a fuel mist into the combustor 30 by an injector (not shown), mixed with the compressed air and ignited by an igniter 32 to be combusted to create the working gas, which is directed by a transition component 34 into the turbine section 20. The working gas is then directed by circumferentially disposed stationary vanes (not shown) in the turbine section 20 to flow across circumferentially disposed rotatable turbine blades 36, which causes the turbine blades 36 to rotate, thus rotating the rotor 24. Once the working gas passes through the turbine section 20 it is output from the engine 12 as an exhaust gas through an output nozzle 38.

The fuel delivery system 14 receives, for example, liquid diesel fuel oil on line 40 at low pressure, which is filtered by a duplex filter assembly 42. The filtered fuel oil is then provided to a pump 44, such as a positive displacement pump, centrifugal pump, etc., operated by a motor 46 that pumps the liquid fuel oil up to a higher pressure and provides the higher pressure fuel oil on a fuel line 48. The system 14 includes a pump discharge regulator 50 that controls the pressure of the fuel oil in the line 48 from the pump 44, where the regulator 50 may draw some of the fuel oil from the line 48 into line 52 and return it to a sump (not shown) on line 54 to regulate the pressure. The flow of the fuel oil from the pump 44 in the line 48 is measured by a flow meter 56 and then sent through an emergency shut off valve 58 that can stop the flow of the fuel oil in the event of an emergency or otherwise.

The fuel oil flowing through the shut off valve 58 is then divided and sent to three separate stages 60 that provide the fuel oil flow to different locations in the combustors 30 in the engine 12, where one of the stages 60 is a pilot stage. Particularly, the fuel oil is selectively injected at one or more of three different locations in the combustor 30 in a manner well understood by those skilled in the art to provide improved combustor performance. The center stage 60 as shown in FIG. 1 will be described herein as representative of all of the stages 60 with the understanding that all three of the stages 60 include the same components and operate in the same manner. The flow rate of the fuel oil through each of the stages 60 is controlled by a control valve 62 and is sent to a three-position multifunction valve 64. As will be described in further detail below, the multifunction valve 64 includes a middle flow-through position 66 for normal operation, a drain position 68 for when the control valve 62 is closed to allow leaked fuel oil to flow into a drain 70 through a check valve 72 on a drain line 74, and a purge position 76 for purging fuel oil downstream of the multifunction valve 64 into the drain 70 as will be discussed in detail below.

FIG. 1 shows the multifunction valve 64 in the flow-through position 66, where the fuel oil flows to a flow divider 78 that evenly distributes the flow of the fuel oil to a plurality of fuel delivery tubes 82, where a separate delivery tube 82 is provided for each of the combustors 30 in the engine 12. In this non-limiting embodiment, the engine 12 includes sixteen of the combustors 30, and thus each of the flow dividers 78 includes sixteen of the fuel delivery tubes 82. For the discussion herein, one of the delivery tubes 82 is shown as flow delivery tube 84 that is coupled to one of the combustors 30 through a check valve 86 and will be described with the understanding that there are fifteen other of the delivery tubes 82 each being coupled to a separate one of the other combustors 30 in the engine 12, and which operate in the same manner. The flow divider 78 is a well known device, and typically includes a motor 80, a gear box (not shown), and a number of positive displacement pump elements 96, where a separate pump element 96 is provided in the divider 78 for each of the delivery tubes 82 and every pump element 96 is synchronized to the other pump elements 96. A pump element is defined herein as those components that encapsulate and transfer a fixed volume of fluid from the low pressure side to the high pressure side for each cycle or rotation of the element. For certain engine operating conditions based on load and other factors the fuel oil is mixed with water injected into the tube 84 from line 88 through a check valve 90 at injection junction 92. This process of mixing water with the fuel oil to control emissions, combustor dynamics, etc., is well known to those skilled in the art.

As is well understood by those skilled in the art, the fuel oil in the tubes 82 is significantly heated by the combustion process in the combustors 30 depending on the distance from the combustor 30. As the fuel oil is being delivered to the combustor 30 for combustion therein, heating of the fuel oil in the tube 82 does not have adverse effects. However, heating of the fuel oil in the tube 82 when the combustor 30 is turned off and the fuel oil is standing therein may cause carbon deposits to form on the inside of the tube 82, which may cause the tube 82 to become clogged, thus affecting the flow rate and pressure of the fuel oil within the tube 82. Thus, for those times that the particular delivery tube 82 is not delivering fuel oil to the particular combustor 30 in the engine 12, which may occur during normal operation of the system 10, such at low loads where one or more of the stages 60 may be inactive, or at system shut down, it is necessary to selectively purge out the fuel oil from the particular tube 82 so as to prevent that fuel oil from heating and depositing carbon on the tube 82.

To perform this purge operation, it is known in the art to use the high pressure injection water available on the line 88 that otherwise would be mixed with the fuel oil as discussed above to purge out the fuel oil in the tube 84. The valve 64 can be positioned in the shut off position 68, where water injected into the tube 82 forces the fuel oil out of the tube 82 downstream of the injection junction 92 through the combustor 30. Further, it also may be desirable to purge the fuel oil out of the particular tube 82 upstream of the injection junction 92 because those areas of the tube 82 can also be subject to high temperatures.

In the known fuel delivery system designs, the flow divider 78 is positioned upstream of the multifunction valve 64 and as such, the flow delivery tubes 82 are coupled directly to the valve 64, where the purge position 76 causes the purged fuel oil to be sent to the drain 70 downstream of the flow divider 78. However, in that design, the flow of the purge water in the tubes 82 upstream of the injection junction 92 was not able to be suitably controlled, thus resulting in purge water possibly being mostly injected into the combustor 30 and not back though the valve 64. Particularly, when purging the fuel oil out of the particular tube 82 upstream of the injection junction 92, to ensure that the tube 82 is properly flushed, it often was necessary to provide a high enough pressure of the injection water that would overcome the check valve 86, which would cause a flow of water into the combustor 30 instead of back through the valve 64. Further, because the flow of the injected water upstream of the injection junction 92 was not controlled, it was not possible to know that all of the tubes 82 were being simultaneously purged during those full purge procedures. More particularly, the purge water that enters the line 88 is supplied by a manifold (not shown) that does not control the flow rate. Because there is no control for dividing the purge water, each tube 82 can receive different amounts of water, where the velocity of the water in the tube 82 is proportional to the flow rate. Since an adequate velocity of the water must be maintained to insure the oil is removed from the interior surface of the tube 82 it cannot be known if the oil has been effectively removed from the interior surface.

The present invention proposes using the flow divider 78 as a mechanism for controlling the flow of the purge water in the tubes 82 upstream of the injection junction 92. Particularly, by operating the motor 80 and the pump element 96 in the reverse direction during the water purge, it can be assured that there is enough flow in the flow delivery tubes 82 during the purge, where all of the tubes 82 can simultaneously be purged. In order to provide this control, the present invention proposes moving the flow divider 78 downstream of the multifunction valve 64 as shown in FIG. 1 so as to control the flow as described, and supplying the flow divider 78 with the necessary motor and gearbox to operate in this manner. The proposed design allows more effective position monitoring of the multifunction valve 64 and provides a more effective use of component space in the system 14.

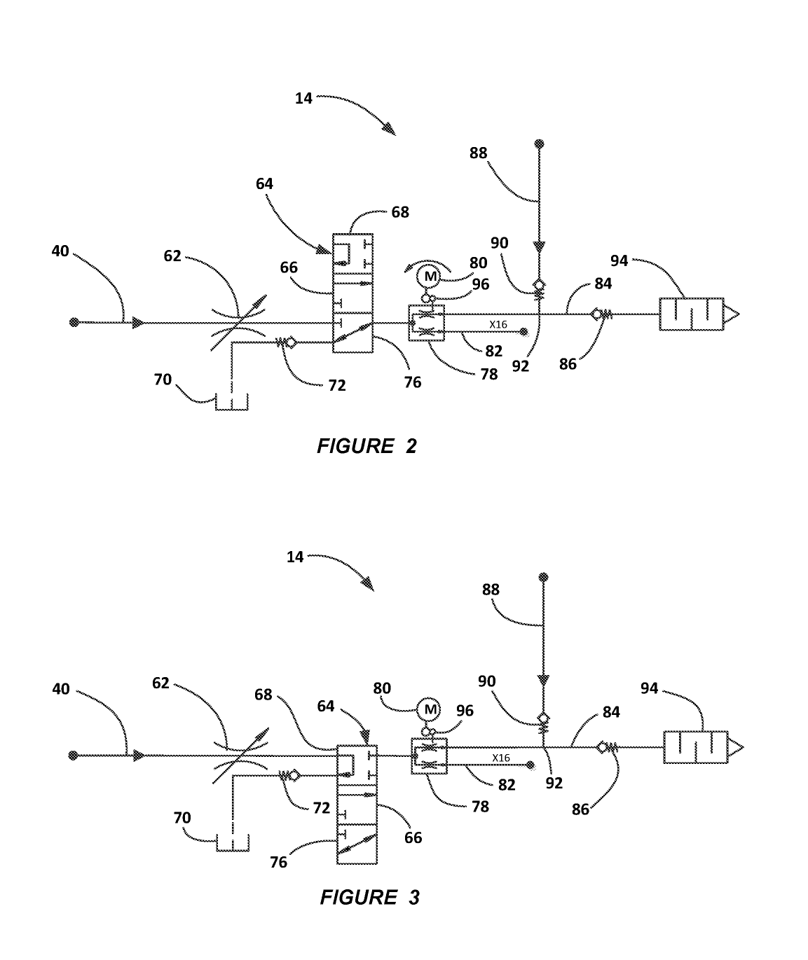

FIG. 2 is a schematic diagram of a portion of the fuel delivery system 14 showing the multifunction valve 64 in the purge position 76. In this illustration, one the combustors 30 is shown as combustor 94. As will be described, all of the flow delivery tubes 82 in each of the stages 60 can be controlled to purge the fuel oil out of the tubes 82 upstream of the injection junction 92 to the drain 70, purge only through the delivery tube 84 downstream of the injection junction 92 through the combustor 30, and purge both upstream and downstream of the injection junction 92, where a controlled amount of the purge water can flow upstream and a controlled amount of the purge water can flow downstream.

With the control valve 62 closed, the multifunction valve 64 in the purge position 76, and the motor 80 operating at a controlled speed in the reverse direction, purge water from the line 88 flows backwards through the flow divider 78 and through the valve 64 into the drain 70, which pushes the fuel oil out of the tubes 82 and into the drain 70. Also, it is possible to split the flow at the junction 92 and simultaneously purge the particular tube 82 in both directions, i.e., to the drain 70 and out through the combustor 94, by controlling the pressure provided by the injection water on the line 88 and the speed of the motor 80 in the reverse direction. The percentage of purge water flowing to the drain 70 and through the combustor 94 can be controlled by controlling the water injection flow and the reverse speed of the motor 80. Thus, for the particular stage 60, at any given system operating condition, all of the tubes 82 for that stage can be purged as described. In this embodiment, during times of system shut off, the flow divider 78 will be full of water, instead of oil as was done in the past, which has advantages for long term life of the system.

FIG. 3 shows the portion of the fuel delivery system 14 shown in FIG. 2, but with the multifunction valve 64 in the closed (drain) position 68. In this mode, the control valve 62 will be closed, but a certain amount of fuel oil will likely leak through the valve 62, where the multifunction valve 64 directs that leakage into the drain 70, as shown. Also, it is possible to selectively purge the tubing 82 downstream of the injection junction 92 with the multifunction valve 64 in the drain position 68 and activating the purge water in line 88.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A fuel delivery system for providing fuel to a plurality of combustors in a gas turbine engine, said fuel delivery system comprising:
a fuel line receiving a liquid fuel;
at least one control valve provided along the fuel line and controlling the flow of the fuel therethrough;
at least one multifunction valve provided along the fuel line downstream from the control valve and including a flow-through position, a drain position and a purge position;
at least one flow divider provided along the fuel line downstream from the multifunction valve, said flow divider directing the fuel in the flow line into a plurality of flow delivery tubes where a separate one of the flow tubes is coupled to a separate one of the combustors, said at least one flow divider including a separate pump element for each flow tube that is controlled to allow flow in both a forward direction and a reverse direction;
a separate water injection line coupled to each of the flow tubes downstream from the at least one flow divider; and
a drain coupled to the at least one multifunction valve, wherein water injected at a certain pressure into the flow tubes from the water injection lines, a speed of the pump elements and the operating direction of the pump elements are controlled so that the flow tubes can be purged through the multifunction valve to the drain and/or through the combustor.

2. The system according to claim 1 wherein the pressure of the injected water, the speed of a particular pump element and the operating direction of the particular pump element are controlled so that all of the flow tubes are simultaneously purged to the drain and through the combustor.

3. The system according to claim 2 wherein the pressure of the injected water, the speed of the particular pump element and the operating direction of the particular pump element are controlled so that a controlled percentage of the water flows to the drain and a controlled percentage of water flows through the combustor.

4. The system according to claim 1 wherein the pump elements are selectively operated in the reverse direction so that the injected water only flows into the drain.

5. The system according to claim 1 wherein the at least one multifunction valve is selectively operated in the drain position so that injected water only flows through the combustor and fuel provided to the at least one multifunction valve is sent to the drain.

6. The system according to claim 1 wherein the at least one control valve is three control valves, the at least one multifunction valve is three multifunction valves and the at least one flow divider is three flow dividers.

7. The system according to claim 1 wherein the plurality of combustors is sixteen combustors and the plurality of flow delivery tubes is sixteen flow tubes.

8. The system according to claim 1 wherein the fuel is diesel fuel oil.

9. A fuel delivery system for providing fuel to a plurality of combustors in a gas turbine engine, said fuel delivery system comprising:
a multifunction valve including a flow-through position, a drain position and a purge position;
a flow divider directing fuel from the multifunction valve into a plurality of flow delivery tubes where a separate one of the flow tubes is coupled to a separate one of the combustors, said flow divider including a pump element for each flow tube that is controlled to operate in both a forward direction and a reverse direction;
a separate water injection line coupled to each of the flow tubes downstream from the flow divider for injecting water into the flow tubes; and
a drain coupled to the multifunction valve.

10. The system according to claim 9 wherein pressure of the injected water, speed of the pump element and the operating direction of the pump element are controlled so that a controlled percentage of the water flows to the drain and a controlled percentage of water flows through the combustor.

11. The system according to claim 9 wherein the pump element is selectively operated in the reverse direction so that the injected water only flows into the drain.

12. The system according to claim 9 wherein the multifunction valve is operated in the drain position so as to allow the injected water to only flow through the combustor and fuel provided to the at least one multifunction valve to flow to the drain.

13. The system according to claim 9 wherein the fuel is diesel fuel oil.

14. A method for purging fuel from one or more flow delivery tubes coupled to one or more combustors in a gas turbine engine, said flow delivery tubes being part of a fuel delivery system, said fuel delivery system including a multifunction valve that selectively allows the fuel to flow in a forward direction and a reverse direction therethrough, and a flow device being coupled to the one or more flow delivery tubes opposite to the one or more combustors and receiving fuel from the multifunction valve, said flow device including at least one pump element, said method comprising:
injecting purge water into the fuel delivery tube downstream of the flow device; and
selectively operating the pump element in a reverse direction so that the injected water flows through the flow device and the multifunction valve to a drain at a defined rate.

15. The method according to claim 14 wherein selectively operating the pump element in a reverse direction includes operating the pump element in the reverse direction in a manner so that the flow tube is simultaneously purged to the drain and through the combustor.

16. The method according to claim 15 wherein selectively operating the pump element includes operating the pump element so that a controlled percentage of the injected water flows to the drain and a controlled percentage of water flows through the combustor.

17. The method according to claim 14 wherein selectively operating the pump element includes operating the pump element in the reverse direction in a manner so that the injected water only flows into the drain.

18. The method according to claim 14 further comprising operating the multifunction valve in a drain position so that the purge water only flows into the combustor.

19. The method according to claim 14 wherein the one or more combustors is a plurality of combustors and the one or flow delivery tubes include a separate flow delivery tube for each combustor.

20. The method according to claim 14 wherein the fuel is diesel fuel oil.
